(19) United States
(12) Patent Application Publication
(10) Pub. No.: US 2024/0161183 A1
(43) Pub. Date: May 16, 2024

(54) METHODS AND ARRANGEMENTS TO DETERMINE QUIZ QUESTIONS

(71) Applicant: Capital One Services, LLC, McLean, VA (US)

(72) Inventors: Leeyat Bracha TESSLER, Arlington, VA (US); Illiana REED, San Francisco, CA (US); Benjamin West POLLAK, Arlington, VA (US); Michael Joseph CIRILLO, Richmond, VA (US); Abhita MOORTHY, Marietta, GA (US); Mia RODRIGUEZ, Broomfield, CO (US)

(73) Assignee: Capital One Services, LLC, McLean, VA (US)

(21) Appl. No.: 17/984,422

(22) Filed: Nov. 10, 2022

(51) Int. Cl. G06Q 40/02; G06Q 30/02

(52) U.S. Cl. CPC G06Q 40/025; G06Q 30/0203; G06Q 30/0217

(57) ABSTRACT

Logic may receive one or more questions from a customer in a chat. The logic may associate the one or more questions with one or more categories of subjects. The logic may store indications of the one or more categories of the subjects with a customer profile. The logic may select questions for a quiz for the customer based on the one or more categories of the subjects in the customer profile from a set of questions. The logic may present the one or more questions to the customer. And, in some embodiments, the logic may receive answers to the one or more questions from the customer.

### TECHNICAL FIELD

Embodiments described herein are in the field of chatbots. More particularly, the embodiments relate to methods and arrangements to determine quiz questions based on interaction between a customer and a chatbot and to quiz the customer with the quiz questions.

### BACKGROUND

Many customers are not well educated in the area of credit and the interrelationships between credit and personal finance. As a result, some customers may use their credit cards in a way that burdens the customer with increased debt and/or increased credit card rates, perform activities that negatively impacts the customer's credit score, and/or perform activities that diminish improvements to the customer's credit score. For instance, applying for a new credit card to transfer a balance to the new credit card can impact a customer's credit score. Whether the impact is negative, neutral, or positive, can depend on the specific customer's credit history. If the customer cancels a credit card that has a long history of credit usage for the customer, the impact on the customer's credit score from canceling the credit card may be negative. Furthermore, if the customer has many credit cards or other revolving credit accounts, applying for a new credit card might have a negative impact on the customer's credit score. On the other hand, if the customer has a significant percentage of debt in installment credits, adding a revolving credit line may have a positive impact of the customer's credit score.

While the Internet has many sources of information related to improving credit scores, the information is spread across multiple web sites and is presented generically or presented with examples of specific situations that are not applicable to some customers. Information about different credit situations or unrelated situations may, inadvertently, mislead a customer about the activities that can improve that customer's credit score.

Such situations can, in some instances, cause a negative impression related to the product offerings, which is neither helpful nor conducive toward cultivating brand loyalty with the customers.

### SUMMARY

Embodiments may include various types of subject matter such as methods, apparatuses, systems, storage media, and/or the like. One embodiment may include an apparatus comprising: memory; and logic circuitry coupled with the memory. In some embodiments, the logic circuitry may receive one or more questions related to credit from a customer in a chat. The logic circuitry may associate the one or more questions with one or more categories of credit subjects. The logic circuitry may store indications of the one or more categories of the credit subjects with a customer profile and select questions for a quiz for the customer based on the one or more categories of the credit subjects in the customer profile from a set of questions related to credit. The logic circuitry may present the one or more questions to the customer. And, in some embodiments, the logic circuitry may receive answers to the one or more questions from the customer.

Another embodiment may comprise a non-transitory storage medium containing instructions, which when executed by a processor, cause the processor to perform operations. The operations may interact with a customer to receive one or more questions related to credit from the customer. The operations may associate the one or more questions with one or more categories of credit subjects. The operations may store indications of the one or more categories of the credit subjects with a customer profile. The operations may select one or more questions for a quiz for the customer from a set of questions related to credit, based on the indications of the one or more categories of the credit subjects in the customer profile and present the quiz to the customer, wherein the quiz comprises the one or more questions. And, in some embodiments, the operations may cause reception of answers to the one or more questions from the customer.

Yet another embodiment may comprise a method. The method may perform operations via a processor. The method may comprise receiving, by the processor, one or more questions related to credit from a customer in a chat. The processor may comprise associating the one or more questions with one or more categories of credit subjects. The processor may comprise storing indications of the one or more categories of the credit subjects with a customer profile and selecting one or more questions for the quiz for the customer from a set of questions related to credit, based on the indications of the one or more categories of the credit subjects in the customer profile. The processor may comprise presenting the quiz to the customer with the one or more questions. And, in some embodiments, the processor may comprise receiving answers to the one or more questions from the customer.

### BRIEF DESCRIPTION OF THE DRAWINGS

FIG. 1A depict an embodiment of a system including servers, networks, data servers, and software applications to determine and pose quiz questions to educate a customer about credit card usage;

FIG. 1B depict an embodiment of a system to train a machine learning engine to determine and pose quiz questions to educate a customer about credit card usage;

FIG. 1C depict an embodiment of a graphical user interface (GUI) to gather information about a customer's credit education gaps to determine and pose quiz questions to educate a customer about credit card usage;

FIG. 1D depict an embodiment of a graphical user interface (GUI) to gather information about a customer's credit education gaps to determine and pose quiz questions to educate a customer about credit card usage;

FIG. 1E depict an embodiment of a credit answers data structure to determine and pose quiz questions to educate a customer about credit card usage;

FIG. 1F depict an embodiment of a gaps data structure to determine and pose quiz questions to educate a customer about credit card usage;

FIG. 1G depict an embodiment of a credit subjects data structure to determine and pose quiz questions to educate a customer about credit card usage;

FIG. 1H depict an embodiment of a quiz questions data structure to determine and pose quiz questions to educate a customer about credit card usage;

FIG. 2 depicts embodiments of an apparatus with question logic circuitry, such as a server(s) 1010 illustrated in FIG. 1A or other computer to determine and pose quiz questions to educate a customer about credit card usage;

FIGS. 3A-C depict flowcharts of embodiments to determine and pose quiz questions to educate a customer about credit card usage, via question logic circuitry, such as the question logic circuitry shown in FIGS. 1A and 2;

FIG. 4 depicts an embodiment of a system including a multiple-processor platform, a chipset, buses, and accessories such as the server and apparatus shown in FIGS. 1A and 2, respectively; and

FIGS. 5-6 depict embodiments of a storage medium and a computing platform such as the server(s) and the apparatus shown in FIGS. 1A and 2, respectively.

### DETAILED DESCRIPTION OF EMBODIMENTS

The following is a detailed description of embodiments depicted in the drawings. The detailed description covers all modifications, equivalents, and alternatives falling within the appended claims.

Embodiments may address technical problems related to determining and posing quiz questions via question logic circuitry. Some embodiments may address technical problems related to determining information about the customer such as gaps in the education of the customer. Some embodiments may address technical problems related to determining quiz questions based on the information. Some embodiments may address technical problems related to use of a chatbot to determine information about the customer. Some embodiments may address technical problems related to identifying subjects associated with interaction between a chatbot and a customer. Some embodiments may address technical problems related to interacting with the customer to receive questions from the customer. Some embodiments may address technical problems related to providing answers to the customer based on questions posed by the customer. Some embodiments may address technical problems related to determining information such as keywords and phrases in a question from the customer. Some embodiments may address technical problems related to determining one or more credit subjects related to the question from the customer. Some embodiments may address technical problems related to determining one or more credit subject categories related to the question from the customer. Some embodiments may address technical problems related to determining credit questions related to credit subjects and/or credit subject categories related to the question from the customer. Some embodiments may address technical problems related to determining or selecting credit questions related to credit subjects and/or credit subject categories related to the question from the customer from a set or pool of credit questions. Some embodiments may address technical problems related to posing credit questions related to credit subjects and/or credit subject categories related to the question from the customer.

Embodiments discussed herein can advantageously improve the technology to determine and pose quiz questions based on interaction between a customer and artificial intelligence of a chatbot to educate customers on credit including, e.g., credit usage and credit scores. Determining or selecting a set of quiz questions for a customer based on interaction between the customer and artificial intelligence of a chatbot can advantageously improve the customer's experiences in relation to credit usage and credit scores as well as the customer's experiences with a credit card brand. Some embodiments may improve current systems with question logic circuitry by, e.g., interacting with a customer via a chatbot to identify credit education gaps of the customer and to answer questions related to credit education gaps based on the customer's specific credit history and/or customer profile.

In some embodiments, the question logic circuitry may receive a chat text from the customer with a question or comment related to credit. The question logic circuitry may interpret the question via a natural language processing model. In many embodiments, the question logic circuitry may pre-process the chat text to remove or replace non-alphanumeric characters, and then to tokenize and stem the chat text prior to text vectorization. Tokenization may involve representation of the words, characters, and/or subwords (n-grams) as tokens (numeric representations of the words, characters and/or subwords).

The question logic circuitry may perform stemming to group inflected forms of a word so the inflected forms of the word may be analyzed as a single item, or stem. Other embodiments may include further pre-processing of the chat text.

Text vectorization is the process of converting text into numerical representations. Text vectorization may include natural language processing with one or more processes such as Binary Term Frequency; Bag of Words (BoW) Term Frequency (TF); (L1) Normalized Term Frequency (L1 TDF); (L2) Normalized Term Frequency-Inverse document frequency (L2 TF-IDF); and word-to-vector (Word2Vec). Binary Term Frequency captures presence (1) or absence (0) of term in the chat text. BoW Term Frequency captures frequency of term in the chat text. (L1) Normalized Term Frequency captures normalized BoW term frequency in the chat text. (L2) Normalized TFIDF captures normalized TFIDF in the chat text.

After the question logic circuitry pre-processes the chat text, the question logic circuitry may implement a credit subject model to predict a set of categories of credit subjects associated with the chat text. For instance, the credit subject model may be trained with chat text from customers that have already been associated with credit subjects. In such embodiments, the credit subject model may predict one or more credit subject categories associated with the chat text and compare the one or more credit subject categories with credit subject categories maintained in a database.

In other embodiments, the credit subject model may cluster a chat text based on keywords and phrases to associate the chat text with one or more categories of credit subjects. Such credit subject models may be trained based on historical chat text to associate clusters of words and/or phrases from the chat text with credit subject categories.

In other embodiments, the credit subject model may remove words and characters other than keywords and phrases such keywords and phrases descriptive of credit subjects and categories. In some embodiments, the credit subject model may expand the keywords and phrases with variations and synonyms of the keywords and phrases prior to correlation of the keywords and phrases with the descriptions of the credit subjects and categories in a credit subjects data structure.

After identifying the categories of credit subjects, the question logic circuitry may store the credit subject categories in a customer database such as a gaps portion of a customer profile and the chat model may process the credit subject categories to identify a credit answer associated with the chat text from the customer. In some embodiments, the chat model may ask the customer to confirm that a credit answer presented to the customer is responsive to the customer's question. In other embodiments, the chat model may identify a question associated with a credit answer in the credit subjects data structure and ask the customer to confirm that the question accurately represents the question that the customer asked.

To answer the question, the chat model may access the customer's credit history and/or customer profile as well as a database of credit answers. The credit answers database may, in some embodiments, advantageously, include a data structure configured to find credit answers for customers. The credit answers database may include credit subjects, credit categories, one or more factors that may be accessed in a credit profile, one or more factors that may be accessed from a credit history, and/or other factors.

The one or more factors of the credit profile may include personal income, total household income, profession, years in profession, years at current employer, years at current address, marriage status, and/or the like. The one or more factors of the credit history may include the number of accounts opened recently or within a predetermined period of time, a total number of revolving credit accounts, a total number of installment credit accounts, a total amount of open credit accounts, a total amount of revolving credit, a total amount of revolving debt, a total amount of installment credit, a total amount of installment credit debt, a ratio of revolving debt to total debt, a ratio of installment credit debt to total debt, a ratio of revolving debt to installment credit debt, and/or the like.

In some embodiments, the categories of credit subjects, factors from the credit profile, and factors from the credit history of the customer may be vectorized and provided as input to the credit answer model to identify a credit answer for the credit question posed by the customer. The credit answer may include an explanation about how the credit history and/or customer profile affects the credit answer specifically for the customer. In some embodiments, the credit answer may also include some general information about how a credit history and/or customer profile may affect a credit score associated with the customer. In some embodiments, the identification of the credit answer may include an indication of (such as an offset or an identifier for) the location of the credit answer in the credit answers database. In other embodiments, a credit answer algorithm may identify the credit answer within the credit answers database based on the credit subject, credit subject category, credit profile factor(s), credit history factor(s), and/or the like.

To illustrate, the customer may ask if opening a new credit card account will negatively impact the customer's credit score. The chat model may access the credit answers database to answer the question. In some embodiments, the chat model may include or have access to a credit answer model such as a machine learning model or a credit answer algorithm to answer the question based on the credit history and customer profile for the customer. For instance, the credit answer model or credit answer algorithm may use factors such as the customer's mix of credit accounts, total debt, portion of total debt in revolving accounts, income, and profession to identify a credit answer in the credit answer database. And the credit answer may include a statement that that opening the new credit card account might have a negative impact on the customer's credit score or that opening the new credit card account might have a positive impact on the customer's credit score. In some embodiments, the credit answer model may also include, as part of the credit answer, a general explanation about how the opening a credit card represents the opening of a revolving credit (or line of credit) and how the customer's mix of credit accounts can affect the customer's credit score.

In some embodiments, the question logic circuitry may also suggest alternative actions to increase credit available to the customer while maintaining a neutral impact on the customer's credit score, increasing the customer's credit score, or minimizing a negative impact on the customer's credit score. For instance, the question logic circuitry may, via a chat box, also state that if the customer desires additional credit, opening a non-revolving credit line such as an installment credit account may increase the customer's credit score by improving the mix of credit accounts in the customer's credit history.

After chatting with the customer, storing indications of the education gaps of the customer in a customer database, and answering the credit questions for the customer, a quiz model of the question logic circuitry may determine to ask the customer if the customer wants to take a credit quiz. After asking the customer and receiving a positive response, the quiz model may access the education gaps in the customer database for the specific customer and may select or prioritize one or more questions from a quiz questions database based on the credit information provided to the customer in response to determination of the education gaps. In other words, the quiz model may quiz the customer on the credit subject matter provided to the customer during a chat session with the customer. Asking quiz questions of the same credit subject matter may advantageously reinforce learning of that credit subject matter by the customer. In other words, embodiments may, advantageously, improve the technology of teaching credit subject matter to the customer by identifying education gaps of a customer, providing answers to the customer based on the customer's credit history and/or customer profile, and, at one or more points in time thereafter, asking the customer to answer questions related to the education gaps identified for the customer.

In some embodiments, the quiz may include one or more questions related to the customer's specific credit history and/or profile. In some embodiments, the quiz questions may be related to general credit subject matter that was provided to the customer in response to the customer's credit questions. In some embodiments, the quiz questions may be related to a combination of the general credit subject matter and how the subject matter applies to the customer's current credit history and/or profile. For instance, while identifying education gaps of the customer, the question logic circuitry may provide general explanations about factors that might change the customer's credit. After the customer updates the customer's profile, the quiz model may request that the customer take a quiz related to the change and may ask the customer quiz questions related to the effect of the update in the customer's profile on the customer's credit.

In some embodiments, the quiz model may wait for an expiration of time or the occurrence of an event before asking the customer to take a quiz on education gaps identified for the customer. For instance, in some embodiments, the quiz model may only quiz the customer on education gaps determined during prior login sessions. In some embodiments, the quiz model may wait a predetermined period of time (such as one or more days) before asking the customer to respond to questions related to the customer's education gaps. In some embodiments, the education gaps indicated in the customer database may include time and date indications to identify the time and/or date on which the customer asked questions and received answers about the customer's credit.

Further embodiments may advantageously improve the technology of teaching credit subject matter to the customer by, e.g., offering incentives and/or rewards. In some embodiments, the quiz model may offer incentives to the customer to take the quiz. In further embodiments, the quiz model may offer incentives to the customer to answer one or more or all the questions of the quiz correctly. For instance, the quiz model may offer a five-dollar reduction on an outstanding balance in response to answering all (e.g., three) quiz questions correctly. In other embodiments, the quiz model may offer an opportunity to the customer to purchase special merchandise or receive a cash back offer for making a purchase that meets identified parameters such a cost, a particular store, within a specified time of period, and/or the like. In some embodiments, the offers may be based on a transaction history of the customer's credit card such as a five-dollar gift card for a purchase at an online retailer based on historical purchases by the customer at the online retailer. In some embodiments, the incentives may include an increase to the percentage of a cash back reward offered to the customer at, e.g., the end of year. In some embodiments, the quiz model may offer increases to a line of credit offered to a customer based on correctly answering quiz questions of one or more quizzes.

After the customer answers the questions, the quiz model may store the results of the quiz with the education gaps in a customer database. For instance, if the customer answers the questions one and two correctly during the quiz, the quiz model may store indications that the customer answered the questions one and two correctly in the customer database. In some embodiments, the indications may be associated with the education gaps of the customer. For instance, if the customer has educations gaps related to three different categories of one or more credit subjects and the customer answers questions correctly, the quiz model may store a count of correctly answered questions, a count of incorrectly answered questions, a time and date for each of the answers, and/or the like, and associated the count(s) and/or time and date, with the corresponding category(ies) of the corresponding credit subject(s).

In some embodiments, the quiz model may prioritize the selection of quiz questions for a customer based on education gaps for categories of credit subjects that the customer tends to answer incorrectly and/or correctly. In some embodiments, the quiz model may prioritize the selection of quiz questions for a customer based on education gaps for categories of credit subjects regardless of whether the customer tends to answer such questions incorrectly or correctly. In some embodiments, the quiz model may prioritize the selection of quiz questions for a customer based on questions asked of the customer during prior quizzes.

In some embodiments, the quiz questions may be maintained in the customer database and may include indications that rank the questions by a difficulty level and/or a complexity level. In some embodiments, the difficulty level of a quiz question may be determined based on the number of customers that tend to answer the quiz question correctly. In some embodiments, the difficulty level may be predetermined based on other factors. In some embodiments, the complexity level of a quiz question may be based on the number of factors of the customer's credit history and/or credit profile that are required to answer the question correctly.

In some embodiments, the quiz model may adjust prioritization of the questions to avoid repeatedly asking questions of a customer at a difficulty level or a complexity level that might frustrate the customer. For instance, the quiz model may include questions associated with a low difficulty level (e.g., levels 1-5) in addition to questions associated with a high difficulty level (e.g., levels 6-10) so the customer can correctly answer at least some of the questions of the quiz. In other embodiments, the quiz model does not account for the level of difficulty of the credit questions and/or the level of complexity of the quiz questions.

In still other embodiments, the quiz model may offer quizzes with questions based on the credit subjects without the identifying education gaps as those credit subjects beforehand by generally prioritizing the selection of quiz questions for a customer based on education gaps of customers generally or of customers with similar factors in customer profiles and/or credit histories. In some embodiments, the quiz model may present statements in a chat box or on a web site page to encourage the customer to ask questions about credit and/or take quizzes for incentives or rewards to test the customer's knowledge about credit.

Several embodiments comprise systems with multiple processor cores such as central servers, modems, routers, switches, servers, workstations, netbooks, mobile devices (Laptop, Smart Phone, Tablet, and the like), and the like. In various embodiments, these systems relate to specific applications such as healthcare, home, commercial office and retail, security, industrial automation and monitoring applications, financial services, and the like.

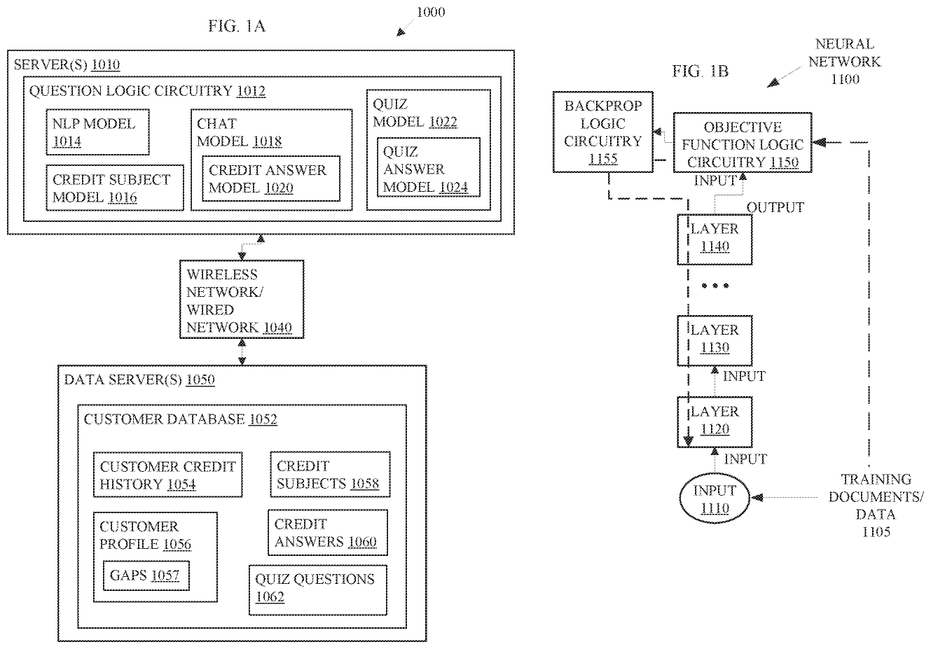

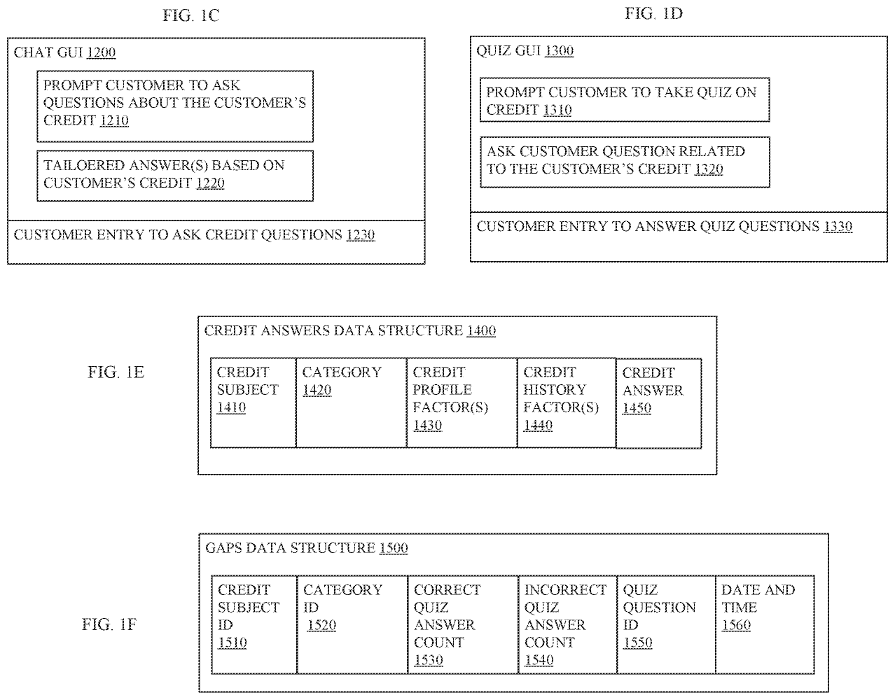

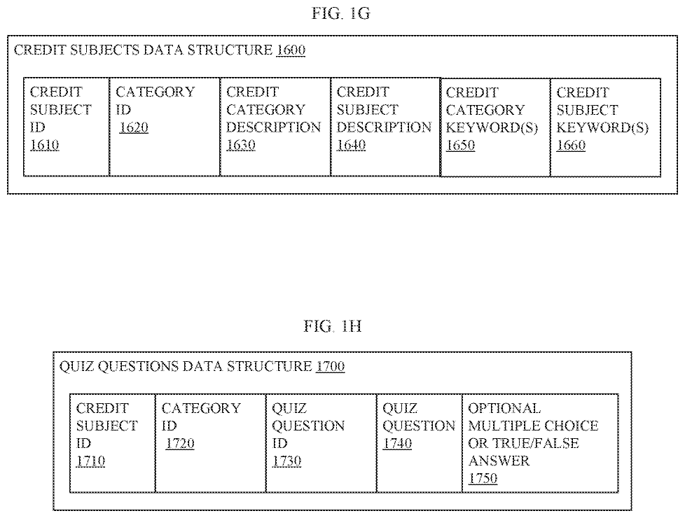

Turning now to the drawings, FIGS. 1A-111 depict embodiments of systems including servers, networks, data servers, and chat box models and applications to determine and pose quiz questions to educate a customer about credit card usage. FIG. 1A illustrates an embodiment of a system 1000. The system 1000 may represent a portion of at least one wireless or wired network 1040 that interconnects server(s) 1010 with data server(s) 1050. The at least one wireless or wired network 1040 may represent any type of network or communications medium that can interconnect the server(s) 1010 and the data server(s) 1050, such as a cellular service, a cellular data service, satellite service, other wireless communication networks, fiber optic services, other land-based services, and/or the like, along with supporting equipment such as hubs, routers, switches, amplifiers, and/or the like.

In the present embodiment, the server(s) 1010 may represent one or more servers owned and/or operated by a company that provides services. In some embodiments, the server(s) 1010 represent more than one company that provides services provided via question logic circuitry 1012. For example, a first set of one or more server(s) 1010 may provide services including a natural language processing (NLP) model 1014 to generate pre-process and/or vectorize text from a chat. The question logic circuitry 1012 may pre-process the chat text to remove or replace non-alphanumeric characters, and then to tokenize and stem the chat text prior to text vectorization.

A second set of one or more server(s) 1010 may include a credit subject model 1016 to correlate chat text with credit subjects. In some embodiments, the credit subject model 1016 may correlate the chat text with one or more categories of one or more credit subjects to identify credit subject matter associated with the chat text provided by the customer. After identifying the credit subjects and/or categories of the credit subjects associated with the chat text from the customer, the credit subject model 1016 may pass the credit subjects and/or categories of the credit subjects to the chat model 1018. In many embodiments, the credit subject model 1016 may store indications of the credit subjects and/or categories of the credit subjects in the gaps 1057 data structure of the customer profile 1056 data structure for the customer in the customer database 1052 on the data server(s) 1050. In other embodiments, the chat model 1018 may store the credit subjects and/or categories of the credit subjects in the gaps 1057 data structure. In still other embodiments, a different portion of the question logic circuitry 1012 may store the credit subjects and/or categories of the credit subjects in the gaps 1057 data structure.

In some embodiments, the credit subject model 1016 may correlate the chat text with credit subjects in the credit subjects 1058 data structure of the customer database 1052. In some embodiments, the credit subjects 1058 data structure may include a complete list of credit subjects, a complete list of categories associated with each of the credit subjects, and an identifier (ID) or offset for identifying a location or record within the data structure for each of the categories of each of the credit subjects. In such embodiments, the credit subject model 1016 may pass the ID or offset for each of the credit subjects and/or each of the categories of the credit subjects to the chat model 1018.

A third set of one or more server(s) 1010 may include a chat model 1018 to interact with the customer in a chat box, such as the chat GUI 1200 shown in FIG. 1C, to identify education gaps, identify credit questions, and to provide credit answers responsive to the credit questions. For example, the chat model 1018 may open a chat box, prompt the customer for chat text, and/or respond to the chat text. The chat model 1018 may communicate the chat text from the customer to the NLP model 1014 to vectorize the chat text and may provide the vectorized chat text to the credit subject model 1016 to identify credit subjects and/or categories of credit subjects as education gaps indicated by the chat text. If the chat text does not include identifiable credit subjects, the chat model 1018 may ask the customer to rephrase the question about credit.

After identifying the education gaps of the customer, the chat model 1018 may store the education gaps in a gaps 1057 data structure of the customer profile 1056. In other embodiments, the credit subject model 1016 may store the education gaps in the gaps 1057 data structure. In still other embodiments, the education gaps may be stored in another location in the customer database 1052 or in the server(s) 1010.

The chat model 1018 may interact with a credit answer model 1020 to determine a credit answer correlated with the credit subject(s) and/or category(ies) of credit subjects identified by the credit subjects model 1016. In some embodiments, the credit answer model 1020 may comprise an algorithm to correlate the credit subject(s) and/or category(ies) of credit subjects with entries for credit answers 1060 data structure in the customer database 1052. In other embodiments, the credit answer model 1020 may comprise a machine learning model such as a neural network or a clustering model.

The neural network may be a supervised learning model such as the neural network 1100 shown in FIG. 1B, that receives training data such as credit subject(s) and/or category(ies) of credit subjects extracted from chat text that has already been associated with a credit answer in the credit answers 1060 data structure. After training with the training data, the neural network may determine, within a margin of error, which credit answer in the credit answers 1060 data structure is most closely related to vectorized text of credit subject(s) and/or category(ies) of credit subjects extracted from a new chat text.

The clustering model may be trained via unsupervised training to cluster chat text in two or more clusters, each representing a different credit answer in the credit answers 1060 data structure. Such clustering models may determine the closest cluster association with the vectorized text of credit subject(s) and/or category(ies) of credit subjects extracted from a new chat text.

In some embodiments, the credit answer model 1020 may output a classification of the chat text as being associated with a particular credit answer to the chat model 1018. In other embodiments, the credit answer model 1020 may output a probability of the chat text as being associated with a particular credit answer in the credit answers 1060 data structure. If the correlation between the chat text and a credit answer is below a threshold, such as below a predetermined probability, the chat model 1018 may interact with the customer to obtain an additional chat text description of the credit question that the customer has asked. In some embodiments, the credit subject(s) and/or category(ies) of credit subjects extracted from the additional chat text may be added to the prior chat text and input as vectorized text into the credit answer model 1020. In further embodiments, the credit subject(s) and/or category(ies) of credit subjects extracted from the additional chat text may be input as vectorized text into the credit answer model 1020 in lieu of the prior chat text to identify the credit answer.

A fourth set of one or more server(s) 1010 may include a quiz model 1022 to determine when to quiz the customer based on education gaps in the gaps 1057 data structure, prioritize credit questions to ask the customer based on the education gaps, and, in some embodiments, store results of the quiz in the customer profile 1056 for the customer. In further embodiments, the quiz model 1022 may store an indication of an achievement in relation to one or more quizzes that the customer earned an incentive and/or a reward. The quiz model 1022 may store the indication of the achievement in the customer profile 1056 data structure, may transmit an indication of the achievement to the customer via contact information in the customer profile 1056, and/or may transmit an indication of the achievement to another component of the server(s) to log and/or activate the incentive or reward.

In some embodiments, the quiz model 1022 may interact with a customer via a chat box such as the quiz GUI 1300 shown in FIG. 1D. The quiz model 1022 may ask a customer if the customer would take a quiz related to credit and may offer incentives and/or rewards to the customer to take one or more quizzes. If a customer has asked credit questions in the chat model 1018 or has otherwise indicated education gaps that are stored in the gaps 1057 data structure of the customer profile 1056, the quiz model 1022 may base selection or prioritization of one or more quiz questions on the education gaps of the customer.

In some embodiments, an instance of the quiz model 1022 may be executed after a customer logs on the server(s) 1010 to, e.g., check a balance on a credit card account or other bank account. The quiz model 1022 may check the customer's profile to determine if the gaps 1057 data structure includes indications of one or more education gaps. The gaps 1057 data structure may include, in some embodiments, one or more records comprising at least one data field.

With education gaps identified from the customer profile 1056, the quiz model 1022 may identify one or more questions in the quiz questions 1062 data structure of the customer database 1052 such as the quiz questions data structure 1700 shown in FIG. 1H. In some embodiments, the quiz model 1022 may prioritize selection of a quiz question from a particular category of a credit subject based on the gaps 1057 indicated the customer profile 1056 and, in some of these embodiments, based on the last date on which the customer answered a question in the category as well as whether the customer answered the credit question correctly or incorrectly.

The quiz model 1022 may identify the quiz questions in the quiz questions 1062 data structure by searching for one or more quiz questions that include a particular credit subject ID and a particular category ID based on the credit subject ID and the credit category ID in the gaps 1057. For instance, the quiz model may receive a credit subject ID and a category ID from the credit subject model 1016 and may search for one or more or all the quiz questions in the quiz questions 1062 data structure that have matching credit subject and category IDs.

In some embodiments, the quiz model 1022 may select a quiz question from the multiple IDs based on the absence of an indication in the gaps 1057 that the customer was previously asked the question such as an absence of the quiz question ID in the gaps 1057. In further embodiments, if all the questions in the credit subject ID and category ID have been presented to the customer in a quiz, the quiz model 1022 may select the quiz question ID associated with the oldest date and time stamp in the gaps 1057. In other embodiments, the quiz model may use other criteria to select the quiz question. In other embodiments, the credit subject model 1016 may provide the quiz model 1022 with a credit subject description and a category description and the quiz model 1022 may look up the credit subject ID and the category ID based on the descriptions.

After selecting one or more questions to ask the customer, the quiz model 1022 may present the quiz questions in a chat box such as the quiz GUI 1300 shown in FIG. 1D. The quiz model 1022 may receive the answer to the question in the form of a choice for a multiple-choice quiz question, a true or false answer for a true-false question, or in the form of chat text for a written answer. For embodiments that implement a multiple-choice quiz question or a true-false quiz question, the quiz model 1022 may compare the choice indicated by the customer to the answer provided with the multiple-choice question or the true-false question. Thereafter, the quiz model 1022 may store the results in the gaps 1057 and, if a reward or incentive is earned, store an indication to the reward or incentive in the customer profile, cause transmission of a communication to the customer to memorialize the earned reward or incentive, and, in some embodiments, cause transmission of a communication to initiate the process of providing the reward or incentive to the customer.

For embodiments that implement a written answer format for a quiz question, the quiz model 1022 may pass the answer to the NLP model 1014 to determine vectorized text for the answer and pass the vectorized text to a quiz answer model 1024 to determine if the answer is correct. In some embodiments, the quiz answer model 1024 may process the customer's answer to predict whether the answer is correct or to classify the answer as either correct or incorrect. In such embodiments, the quiz answer model 1024 may be trained with training data including chat text answers that are already identified as correct or incorrect. In some embodiments, the training data includes all incorrect answers and the quiz answer model 1024 may determine the correlation of the customer's answer with incorrect answers. In some embodiments, the training data includes all correct answers and the quiz answer model 1024 may determine the correlation of the customer's answer with correct answers. And, in some embodiments, the training data includes both correct answers and incorrect answers and the quiz answer model 1024 may determine the correlation of the customer's answer with correct and incorrect answers to determine if the customer's answer is correct or incorrect. The quiz model 1022 may store the results in the gaps 1057, store an indication to the reward or incentive in the customer profile if a reward or incentive is earned, cause transmission of a communication such as an email or a text to the customer to memorialize the earned reward or incentive, and, in some embodiments, cause transmission of a communication to initiate the process of providing the reward or incentive to the customer.

In other embodiments, the quiz answer model 1024 may correlate language of the customer's quiz answer with language in the credit answer associated with the same credit subject and category to determine an extent or probability of the correlation. If the extent or probability is above a threshold such as 90 percent, the quiz model 1022 may determine that the customer has answered the quiz question correctly. Otherwise, the quiz model 1022 may determine that the customer has answered the question incorrectly. Thereafter, the quiz model 1022 may store the results in the gaps 1057, store an indication to the reward or incentive in the customer profile if a reward or incentive is earned, cause transmission of a communication to identify or memorialize the earned reward or incentive.

FIG. 1B generally describes a way to train a machine learning engine or model such as a neural network (NN) 1100 with supervision (supervised learning). The NN 1100 may comprise a deep neural network (DNN).

A DNN is a class of artificial neural network with a cascade of multiple layers that use the output from the previous layer as input. An example of a DNN is a recurrent neural network (RNN) where connections between nodes form a directed graph along a sequence. A feedforward neural network is a neural network in which the output of each layer is the input of a subsequent layer in the neural network rather than having a recursive loop at each layer.

Another example of a DNN is a convolutional neural network (CNN). A CNN is a class of deep, feed-forward artificial neural networks. A CNN may comprise an input layer and an output layer, as well as multiple hidden layers. The hidden layers of a CNN typically consist of convolutional layers, setting layers, fully connected layers, and normalization layers.

The NN 1100 comprises an input layer 1110, and three or more layers 1120 and 1130 through 1140. The input layer 1110 may comprise input data including training data training documents/data 1105, such as the historical chat text including credit questions and/or quiz answers, to train the credit answer model 1020 and/or the quiz answer model 1024, and the subject matter model 1016 to perform functionality discussed herein. The input layer 1110 may provide the data in the form of tensor data to the layer 1120. The tensor data may include a vector, matrix, or the like with values associated with each input feature of the NN 1100.

In many embodiments, the input layer 1110 is not modified by backpropagation. The layer 1120 may compute an output and pass the output to the layer 1130. Layer 1130 may determine an output based on the input from layer 1120 and pass the output to the next layer and so on until the layer 1140 receives the output of the second to last layer in the NN 1100. Depending on the methodology of the NN 1100, each layer may include input functions, activation functions, and/or other functions as well as weights and biases assigned to each of the input features. The weights and biases may be randomly selected or defined for the initial state of a new model and may be adjusted through training via backwards propagation (also referred to as backpropagation or backprop). When retraining a model with, e.g., with additional training data obtained after an initial training of the model, the weights and biases may have values related to the previous training and may be adjusted through retraining via backwards propagation.

The layer 1140 may generate an output, such as a probability or classification, and pass the output to an objective function logic circuitry 1150. The objective function logic circuitry 1150 may determine errors in the output from the layer 1140 based on an objective function such as a comparison of the predicted or classification results against the expected results from the training documents/data 1105. For instance, the expected results may be paired with the input in the training data supplied for the NN 1100 for supervised training. In one embodiment, the model may represent a machine learning engine to classify chat text as related to a credit subject and category or not related to the credit subject and category and the expected results may include decisions previous made about whether the chat text in the training data were related to the credit subject and category. In some embodiments, for instance, at least one model is trained for each of the credit subjects and/or each combination of the credit subject and category in the credit answers 1060 data structure.

During the training mode, the objective function logic circuitry 1150 may output errors to backpropagation logic circuitry 1155 to backpropagate the errors through the NN 1100. For instance, the objective function logic circuitry 1150 may output the errors in the form of a gradient of the objective function with respect to the input features of the NN 1100.

The backpropagation logic circuitry 1155 may propagate the gradient of the objective function from the top-most layer, layer 1140, to the bottom-most layer, layer 1120 using the chain rule. The chain rule is a formula for computing the derivative of the composition of two or more functions. That is, if f and g are functions, then the chain rule expresses the derivative of their composition f⋅g (the function which maps x to f(g(x))) in terms of the derivatives of f and g. After the objective function logic circuitry 1150 computes the errors, backpropagation logic circuitry 1155 backpropagates the errors. The backpropagation is illustrated with the dashed arrows.

When operating in inference mode, the credit subject model 1016, the credit answer model 1020, and the quiz answer model 1024 shown in FIG. 1A, may receive feedback. If the feedback is negative, the backpropagation may attribute an error to the output. If the feedback is positive, the backpropagation may reinforce or bias selection of the output within the layers of the NN 1100.

FIG. 1C depicts an embodiment of a chat GUI 1200 for the chat model 1018 illustrated in FIG. 1A. The chat GUI 1200 may comprise chat text presented by the chat model 1018 to prompt the customer to ask questions about the customer's credit 1210. The customer may respond with chat text to ask credit questions 1230 and the chat model 1018 may, advantageously, present chat text responsive to the customer's credit question that is a tailored answer based on the customer's credit history and/or credit profile 1220. In other words, the chat model 1018 may respond to the customer's inquiry with an answer that utilizes the customer's profile and/or credit history to answer to customer's credit question.

FIG. 1D depicts an embodiment of a quiz GUI 1300 for the quiz model 1022 illustrated in FIG. 1A. The quiz GUI 1300 may comprise chat text presented by the quiz model 1022 to prompt the customer to take a quiz about the customer's credit 1310. The customer may respond with chat text to agree to taking the quiz. In response, the quiz model 1022 may ask the customer a quiz question, advantageously, related to the customer's credit 1320, and customer may present chat text responsive to the quiz question 1330. In some embodiments, the chat text responsive to the quiz question may comprise a selection of one or more multiple choice answers.

FIG. 1E illustrates an embodiment of a credit answers data structure 1400, which is an embodiment of the credit answers 1060 data structure shown in FIG. 1A. Each record in the credit answers data structure 1400 may comprise data fields such as a credit subject ID 1610 data field, a category ID 1620 data field, a credit profile factor(s) 1430 data field, a credit history factor(s) 1430 data field, and a credit answer 1450 data field. The credit subject ID may comprise an ID to uniquely identify a credit subject in the credit subjects 1058 data structure such as the credit subjects data structure 1600 shown in FIG. 1G. The credit subject ID may comprise an ID to uniquely identify a credit subject in the credit subjects 1058 data structure such as the credit subjects data structure 1600 shown in FIG. 1G.

The credit profile factor(s) 1430 data field may include one or more credit profile factors that can be found in a customer profile 1056 that are associated with the category ID of the credit subject ID of a record in the credit answers 1060. For instance, the one or more credit profile factors may include personal income, other income, total household income, employment status, profession, years in profession, years at current employer, years at previous employer(s), years at current address, years at prior address(es) marriage status, and/or the like. In some embodiments, the credit profile factors may include ranges of values such as a range of personal income, a range of other income, a range of total income, a range of years in profession, a range of years at current employer, a range of years at previous employer(s), a range of years at current address, a range of years at prior address(es), and/or the like.

The credit history factor(s) 1440 data field may include one or more factors that can be found in a customer credit history 1054 that are associated with the category ID of the credit subject ID of a record in the credit answers 1060. For instance, the one or more credit history factors may include the number of accounts opened recently or within a predetermined period of time, a total number of revolving credit accounts, a total number of installment credit accounts, a total amount of open credit accounts, a total amount of revolving credit, a total amount of revolving debt, a total amount of installment credit, a total amount of installment credit debt, a ratio of revolving debt to total debt, a ratio of installment credit debt to total debt, a ratio of revolving debt to installment credit debt, and/or the like. In some embodiments, the credit profile factors may include ranges of values such as a range of the number of accounts opened recently or within a predetermined period of time, a range of a total number of revolving credit accounts, a range of a total number of installment credit accounts, a range of a total amount of open credit accounts, a range of a total amount of revolving credit, a range of a total amount of revolving debt, a range of a total amount of installment credit, a range of a total amount of installment credit debt, a range of ratios of revolving debt to total debt, a range of ratios of installment credit debt to total debt, a range of ratios of revolving debt to installment credit debt, and/or the like.

The credit answer 1450 data field may, advantageously, include an answer tailored to answer a credit question associated with a specific category of a credit subject and associated with particular credit profile factors and credit history factors. For instance, the answer may relate to customers that have a particular range of total debt, have a particular range of total household income, have no delinquencies, have lived in the same residence for a number of years within particular range of years, are employed, have been employed by the same employer for a number of years within a particular range of years, and the like. In some embodiments, each category of a subject matter may have one credit answer for each unique combination of credit profile and credit history factors. In some embodiments, the credit answer 1450 may include both specific information about improvement to a credit rating or score and may also include more general information related to factors that affect a customer's credit score such as revolving credit accounts, debt, payments, payment history, age of accounts, credit utilization of revolving credit accounts, total credit utilization, and/or the like.

FIG. 1F illustrates an embodiment of a gaps data structure 1500, which is an embodiment of the gaps 1057 data structure. Each record in the gaps data structure 1500 may comprise data fields such as a credit subject ID 1510 data field, a category ID 1520 data field, a correct quiz answer count 1530 data field, an incorrect quiz answer count 1540 data field, a quiz question ID 1550 data field, and a data and time 1560. The credit subject ID may comprise an ID to uniquely identify a credit subject in the credit subjects 1058 data structure such as the credit subjects data structure 1600 shown in FIG. 1G. The category ID 1520 data field may comprise an ID to uniquely identify a credit subject category in the credit subjects 1058 data structure such as the credit subjects data structure 1600 shown in FIG. 1G.

The correct quiz answer count 1530 data field may maintain a count of correctly answered quiz questions by the customer for each category of a credit subject. The incorrect quiz answer count 1540 data field may maintain a count of incorrectly answered quiz questions by the customer for each category of a credit subject.

In some embodiments, the counts may be associated with a question ID 1550 and a date and time 1560. The question ID may comprise an identification that uniquely identifies a quiz question and the data and time 1560 data field may include a value such as a time stamp to indicate the date and/or time at which the customer last answered the question associated with the question ID. For instance, the gaps data structure 1500 may also include the date and/or time associated with the correct quiz answer count 1530 data field and/or the incorrect quiz answer count 1540 data field for the quiz question ID 1550 to track the relative timing of the correct and incorrect answers for that question. In some embodiments, the quiz model 1022 may clear the counts of correct and/or incorrect answers after a period of time or after a reward or incentive is issued to the customer. In some embodiments, the quiz model 1022 may prioritize selection of quiz questions from the quiz questions 1062 data structure based on whether the customer answered the specific question associated with a question ID as well as how recently the customer answered the question, which may be indicated by the date and time 1560 data field value.

FIG. 1G illustrates an embodiment of a credit subjects data structure 1600, which is an embodiment of the credit subjects 1058 data structure. The credit subjects data structure 1600 may comprise data fields such as credit subject ID 1610, category ID 1620, credit subject category description 1630, credit subject description 1640, credit category keyword(s) 1650, and credit subject keyword(s) 1660. The credit subject ID 1610 may include a unique identifier associated with a credit subject. The category ID 1620 may include a unique identifier associated with a category of a credit subject. Each credit subject may include one or more categories and each category may represent a different credit topic. For instance, one category of a credit subject may be associated with one credit answer. Thus, by identifying a specific category of a credit subject, the chat model 1022 may find the answer to a customer's credit question by looking up the credit subject and category in the credit answers data structure 1400.

Some embodiments may include more than one subcategory for each category. In such embodiments, a portion of the credit answer for the category may be associated with each subcategory. In some of these embodiments, the subcategories may be associated with overlapping portions of the credit answer and/or different portions of the credit answer.

FIG. 1H illustrates an embodiment of the quiz questions data structure 1700. The quiz questions data structure 1700 may include data fields such as a credit subject ID 1710, a category ID 1720, a quiz question ID 1730, a quiz question 1740, and optionally, a multiple-choice or true-false answer. The credit subject ID 1710 data field may include the unique identifier associated with a credit subject such as the credit subject ID 1510 and 1610 as discussed in FIGS. 1F and 1G, respectively. The category ID 1720 data field may include the unique identifier associated with a category of a credit subject such as the category ID 1520 and 1620 as discussed in FIGS. 1F and 1G, respectively. The quiz question ID 1730 data field may comprise a unique identification for a quiz question in the quiz question 1740 data field.

The quiz question 1740 data field may comprise a quiz question crafted based on specific information or ranges of information that can be found in a customer profile and customer credit history. For instance, records of the quiz questions data structure 1700 may include multiple quiz question IDs associated with the same credit subject ID and category ID that vary based on how differences in the values of different credit profile factors and credit history factors affect customers' credit scores.

In some embodiments, the quiz questions may include multiple-choice questions, true-false questions, and/or the like. In such embodiments, the quiz question data structure may include the optional multiple choice or true-false answer 1750 data field that may include the value(s) of the correct answer(s) to the quiz question in the quiz question 1740 data field.

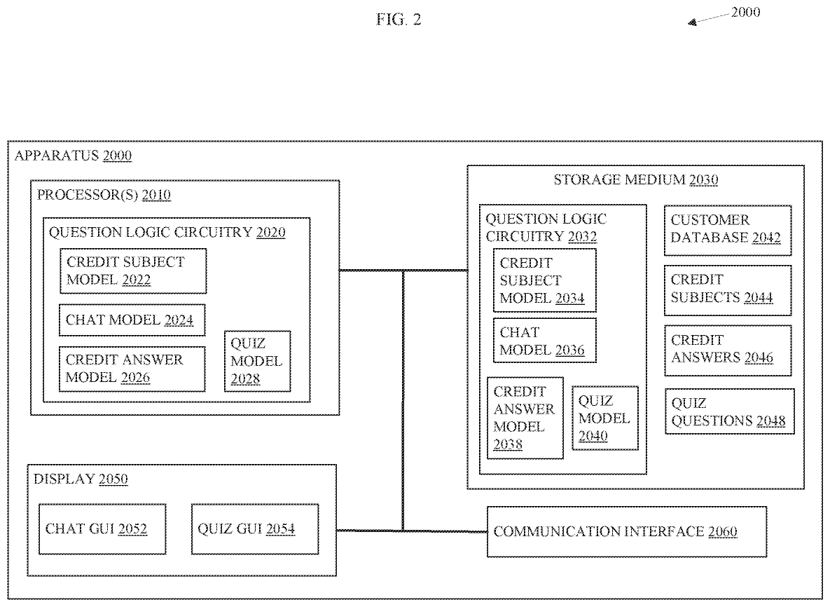

FIG. 2 depicts embodiments of an apparatus 2000 and question logic circuitry 2020 and 2032, such as the server(s) 1010 and models illustrated in FIG. 1A. The apparatus 2000 may be a computer in the form of a smart phone, a tablet, a notebook, a desktop computer, a workstation, or a server. The apparatus 2000 can combine with any suitable embodiment of the systems, devices, and methods disclosed herein. The apparatus 2000 can include processor(s) 2010, a non-transitory storage medium 2020, communication interface 2030, and a display device 2035. The processor(s) 2010 may comprise one or more processors, such as a programmable processor (e.g., a central processing unit (CPU)). The processor(s) 2010 may comprise processing circuitry to implement question logic circuitry 2020 such as the question logic circuitry 1012 in FIG. 1A.

The processor(s) 2010 may operatively couple with a non-transitory storage medium 2020. The non-transitory storage medium 2020 may store logic, code, and/or program instructions executable by the processor(s) 2010 for performing one or more instructions including the question logic circuitry 2032. The non-transitory storage medium 2020 may comprise one or more memory units (e.g., removable media or external storage such as a secure digital (SD) card, random-access memory (RAM), a flash drive, a hard drive, and/or the like). The memory units of the non-transitory storage medium 2020 can store logic, code and/or program instructions executable by the processor(s) 2010 to perform any suitable embodiment of the methods described herein. For example, the processor(s) 2010 may execute instructions such as instructions of the question logic circuitry 2032 causing one or more processors of the processor(s) 2010 represented by the question logic circuitry 2020 to chat with a customer with a chat model 2022 via a chat GUI 2052 to identify education gap(s) of the customer and to educate the customer on credit in response to the customer's questions. The question logic circuitry 2020 may also quiz the customer with a quiz model 2028 via a quiz GUI 2054 to reinforce the customers' credit education.

In many embodiments, the chat model 2024 may interact with a credit subject model 2022 to identify credit subjects and categories associated with a chat text received from the customer via the chat GUI 2052 and may identify credit subject matter such as a credit answer in the credit answers 2046 data structure of the storage medium 2030 to present to the customer in response to the chat text. The credit answers 2046 data structure may include one or more answers related to various data included in the customer's profile and/or the customer's credit history in the credit database 2042. In some embodiments, the credit answers 2046 data structure may include links that reference data in the customer database 2042 to insert values from data fields associated with the customer in a credit answer presented to the customer via the chat GUI 2052. For instance, a credit answer may include a link that is evaluated by the chat model 2024 for presentation on the display 2050 in the chat GUI 2052. The link may include a value from the customer's credit history, credit profile, and/or the like, such as the current, outstanding balance on a credit card.

After identifying education gaps in the form of credit subject(s) and category(ies), the quiz model 2028 may select a time to advertise an opportunity to the customer to take a quiz. In some embodiments, the quiz model 2028 may ask the customer upon logging out of a login session or may present an advertisement during the login session. In some embodiments, the quiz model 2028 may not select or prioritize quiz questions for education gaps based on credit subjects and categories identified during the same login session but may select or prioritize quiz questions for education gaps based on credit subjects and categories identified during a prior login session. In some embodiments, the quiz model 2028 may select or prioritize quiz questions for education gaps based on credit subjects and categories identified during the same login session as long as a minimum time frame has expired such as 10 minutes or 15 minutes. In other embodiments, the quiz model 2028 may select or prioritize quiz questions for education gaps without regard as to when the education gaps were identified.

In many embodiments, the quiz model 2028 may ask multiple-choice quiz questions, true-false quiz questions, and/or the like, and the quiz questions 2048 data structure in the storage medium 2030 may include a set of all quiz questions with quiz answers. The quiz model 2028 may identify two or more quiz questions from the quiz questions 2046 data structure based on education gaps in the customer database 2024 that identify one or more credit subjects and one or more categories of credit subjects. For instance, the credit subjects may include the effect of opening a credit account on the customer's credit, the effect of opening a revolving credit account on the customer's credit, the effect of opening an installment loan account on the customer's credit, the effect of closing an account on the customer's credit, the effect of closing a revolving credit account on the customer's credit, the effect of closing an installment loan account on the customer's credit, the effect of paying an account in full on the customer's credit, the effect of failing to pay at least a minimum payment for an account on the customer's credit, and/or the like. The categories may be defined via specific information about the factors from that specific customer's profile and credit history that may affect the answers to the questions such as the average ages of the customer's accounts in the customer's credit history, the total outstanding balances on the customer's accounts, the total outstanding balances on the customer's revolving credit accounts, the total outstanding balances on the customer's installment loan accounts, the total credit utilization by the customer's accounts, the total credit utilization by the customer's revolving credit accounts, the total credit utilization by the customer's installment loan accounts, the customer's length of employment with a current employer, the customer's employment status as unemployed, the customer's length of residence at the current address, and/or the like.

Some embodiments may include one or more subcategories associated with each category to provide more specific detail about the customer's credit and more granularity for the quiz questions and credit answers. Further embodiments may divide each of the subcategories into a one or more sub-subcategories associated with each subcategory to provide more specific detail about the customer's credit and more granularity for the quiz questions and credit answers.

After asking the quiz questions, the quiz model 2028 may compare the answers provided by the customer against the answers in the quiz questions 2048 data structure to determine if the customer correctly answered the quiz questions and may provide feedback tot eh customer. If the customer incorrectly answered a quiz question, the quiz model 2028 may provide the customer with the correct answers and, in some embodiments, may present the customer with the corresponding credit answer from the credit answers 2046 data structure on the display 2050 via the quiz GUI 2054 to, advantageously, reinforce the learning of the credit education of the customer. If the customer correctly answered the quiz question, the quiz model 2028 may, in some embodiments, present the customer with the corresponding credit answer from the credit answers 2046 data structure on the display 2050 via the quiz GUI 2054 to, advantageously, reinforce the learning of the credit education of the customer.

In some embodiments, the quiz model 2028 may also record the correctly and/or incorrectly answered quiz questions in the customer database 2042. The identification of the correctly and/or incorrectly answered quiz questions in the customer database 2042 may be factored into the selection and/or prioritization of inclusion of quiz questions in a subsequent quiz presented to the customer. Furthermore, the identification of the correctly and/or incorrectly answered quiz questions in the customer database 2042 may facilitate determination of an overall difficulty score or ranking for the questions in the quiz questions 2048 data structure. In some embodiments, the quiz model 2028 may account for the difficulty of quiz questions in the selection and prioritization of quiz questions for inclusion in subsequent quizzes presented to the same and/or other customers.

The non-transitory storage medium 2030 may store code and data for execution by the processor(s) 2010 comprising the question logic circuitry 2032, customer database 2042, credit subjects 2044 data structure, credit answers 2046 data structure, quiz questions 2048 data structure, and/or the like. In many embodiments, the credit subjects 2044 data structure may include a complete set of credit subjects and categories of each of the credit subjects with descriptions and/or keywords to identify and distinguish each of the credit subjects and/or categories of each of the credit subjects. For instance, the subject of the effect of opening a revolving credit account on the customer's credit may include keywords such as open, opening, revolving, credit card, credit line, line of credit, and/or other variations of the keywords and/or phrases that can define and distinguish this credit subject from other credit subjects as well as a define and distinguish this credit subject category from other credit subject categories.

The processor(s) 2010 may couple to a communication interface 2060 to transmit and/or receive data such as customer chat text for a chat GUI 2052 and/or a quiz GUI 2054 from one or more external devices (e.g., a terminal, display device, a smart phone, a tablet, a server, a printer, or other remote device). The communication interface 2060 includes circuitry to transmit and receive communications through a wired and/or wireless media such as an Ethernet interface, a wireless fidelity (Wi-Fi) interface, a cellular data interface, and/or the like. In some embodiments, the communication interface 2060 may implement logic such as code in a baseband processor to interact with a physical layer device to transmit and receive wireless communications such as chat text and/or email from a customer to the question logic circuitry 2020. For example, the communication interface 2030 may implement one or more of local area networks (LAN), wide area networks (WAN), infrared, radio, Wi-Fi, point-to-point (P2P) networks, telecommunication networks, cloud communication, and the like.

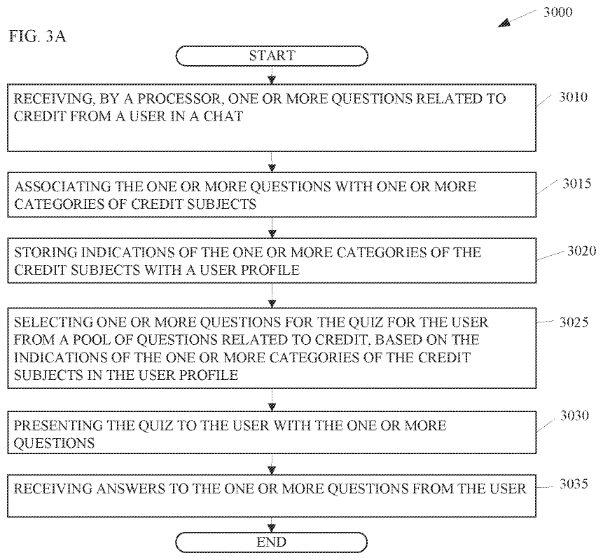

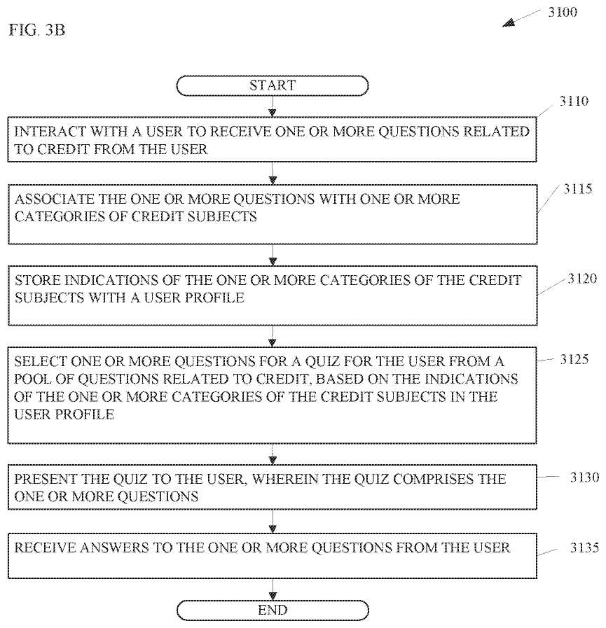

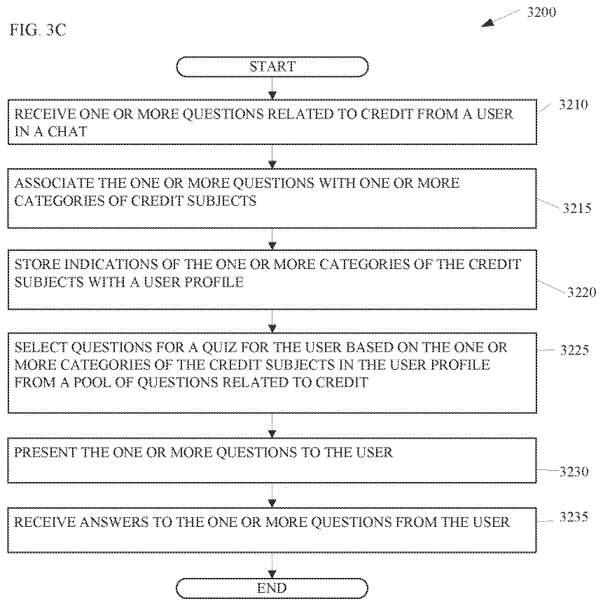

FIGS. 3A-3C depict flowcharts of embodiments to educate customers about credit, by question logic circuitry, such as the question logic circuitry shown in FIGS. 1A and 2. FIG. 3A illustrates a flowchart of a process 3000 to educate a customer about credit. The process 3000 starts with receiving, by a processor, one or more questions related to credit from a customer in a chat (element 3010). For instance, a customer may have questions about credit or how performance of an action such as opening a new mortgage account may affect the customer's credit score. The customer, while logged into a server, such as the server(s) 1010 shown in FIG. 1A, may open a chat GUI or chat box to ask a question about credit. After typing the question, the question logic circuitry may interpret the chat text received from the customer to correlate the question with a credit answer.

The question logic circuitry may also associate the one or more questions with one or more categories of credit subjects (element 3015). For instance, in some embodiments, the question logic circuitry may correlate the chat text from the customer with a credit subject and a category of the credit subject. The question logic circuitry may process the chat text via model such as a natural language processor or other model to identify keywords and phrases in the chat text, and/or identifying root words from the keywords and phrases. The question logic circuitry may compare the keywords, phrases, and root words to keywords, phrases, root words, and/or the like associated with the credit subjects and categories.

In some embodiments, the question logic circuitry may generate scores based on a comparison between the keywords, phrases, and root words associated with the chat text and keywords, phrases, and root words stored in a data structure for the credit subjects and categories. The question logic circuitry may then select one or more of the credit subjects and categories based on the scores.

In other embodiments, the question logic circuitry may compare the keywords, phrases, and root words to keywords, phrases, root words, and/or the like associated with the credit subjects and categories via a clustering model. In such embodiments, the clustering model may identify a cluster associated with a credit subject category based on a correlation between the keywords, phrases, and root words associated with the chat text and the keywords, phrases, root words, and/or the like associated with the credit subjects and categories. The clustering model may classify the chat text as associated with a credit subject and category or may output a probability that the chat text is associated with one or more of the credit subjects and categories.

After identifying one or more of the credit subjects and categories associated with the chat text from the customer, in some embodiments, the question logic circuitry may look up select one or more of the credit subjects and categories that represent the closest match with the chat text.

After determination of the credit subject and category, the question logic circuitry may store indications of the one or more categories of the credit subjects with a customer profile (element 3020). The indications of the one or more categories of the credit subjects from the customer's questions are considered education gaps and are stored in the customer database so that these education gaps can be accessed by the question logic circuitry for the purposes of quizzing the customer at a later time.

The question logic circuitry may advertise an opportunity to the customer to take a quiz, and in response to an indication that the customer wants to take the quiz, the question logic circuitry may select one or more questions for the quiz for the customer from a set of questions related to credit, based on the indications of the one or more categories of the credit subjects in the customer profile (element 3025). In some embodiments, the question logic circuitry may not select or prioritize questions related to education gaps most recently identified for the customer. In such embodiments, the question logic circuitry may select or prioritize questions related to education gaps identified for the customer during one or more prior login sessions.

After selecting the one or more quiz questions, the question logic circuitry may present the quiz to the customer with the one or more questions (element 3030). In some embodiments, the question logic circuitry may present the quiz questions in a quiz GUI such as the quiz GUI 2054 discussed in conjunction with FIG. 2. The quiz GUI may present the questions all at once or one at a time. In some embodiments, the presentation of the quiz questions in the quiz GUI may depend on the platform from which the customer logs into the question logic circuitry. For instance, if the customer accesses the question logic circuitry via a smart phone, the question logic circuitry may present the quiz questions sequentially. On the other hand, if the customer accesses the question logic circuitry from a desktop computer, a tablet, or the like, the question logic circuitry may display the quiz with all the quiz questions at the same time, or as pages including subsets of the quiz questions. In some embodiments, the question logic circuitry may access the size of the screen or window being used to display the quiz GUI and adjust the presentation of the quiz questions based on the size of the screen and the length of the quiz questions.

Once the question logic circuitry displays the quiz questions, the question logic circuitry may receive answers to the one or more questions from the customer (element 3035). The question logic circuitry may evaluate the answers based on answers included with the quiz questions or based on correlation of the answers with a credit answer data structure that includes a set of all the answers for the quiz questions.

After the quiz is completed by the customer, the question logic circuitry may store a result of the quiz in the customer profile. The result of the quiz may be indicative of the customer's knowledge of one or more of the credit subjects.

FIG. 3B illustrates a flowchart of a process 3100 to educate a customer about credit. The process 3100 begins with interacting with a customer to receive one or more questions related to credit from the customer (element 3110). In some embodiments, question logic circuitry may prompt the customer to ask questions about the customer's credit

After receiving one or more questions from the customer in the form of chat text, the question logic circuitry may associate the one or more questions with one or more categories of credit subjects (element 3115). In some embodiments, the question logic circuitry may interpret the chat text received from the customer via a natural language processing model and a credit subject model to determine the credit subjects and categories that are included in the chat text received from the customer. In many embodiments, the credit subject model may implement a clustering model or other machine learning engine to determine the credit subjects and categories. For instance, the credit subject model may structure vectorized text from the chat text as input data for a machine learning engine and the machine learning engine may output a classification of the chat text as related to a subject and category or may output a probability for of association of the chat text with one or more the credit subjects and categories. The question logic circuitry may identify the credit subjects and categories as education gaps associated with the customer so the customer may be quizzed based on the credit subjects and categories at a later time.

In many embodiments, the question logic circuitry may store indications of the one or more categories of the credit subjects with a customer profile (element 3120). In some embodiments, question logic circuitry may store the indications of the one or more categories of the credit subjects in a data structure within a customer profile. In other embodiments, the question logic circuitry may store the indications of the one or more categories of the credit subjects in a data structure associated with the customer profile.

In some embodiments, the question logic circuitry may select one or more questions for a quiz for the customer from a set of questions related to credit, based on the indications of the one or more categories of the credit subjects in the customer profile (element 3125). In some embodiments, selection of one or more questions for the quiz for the customer from the set of questions related to credit may be based on the result of a previously administered quiz. For example, if the customer answers a quiz question incorrectly, an indication that the customer answered the question incorrectly may be included in the education gaps data structure associated with the customer's profile such that the question logic circuitry may prioritize questions related to the same subject matter for quiz questions.

In some embodiments, the question logic circuitry may implement a machine learning engine to select the one or more questions from a set of questions for the quiz based on the indications of the one or more categories of credit subjects in the education gaps associated with the customer. For instance, the question logic circuitry may provide input to a machine learning engine including the categories of education gaps as well as information from the customer's profile and credit history to identify quiz questions from a set of quiz questions to present to the customer in a quiz.

In some embodiments, the question logic circuitry may select questions having a level of difficulty based on the customer's ability to answer questions from the quizzes correctly. For instance, the quiz questions may be ranked based on the ability of customers to answer the questions correctly. If many customers answer a quiz question incorrectly, the question may be marked as difficult. If many customers answer a quiz question correctly, the question may be marked as easy. If about half the customers answer a quiz question correctly and half answer the question incorrectly, the question may be marked as having medium difficulty.

Once quiz questions are selected, the question logic circuitry may present the quiz to the customer with the one or more questions (element 3130). The question logic circuitry may then receive answers to the one or more questions from the customer (element 3135). In some embodiments, the question logic circuitry may offer the customer an incentive or reward if the customer participates in the quiz or answers one or more or all the questions correctly.

FIG. 3C illustrates a flowchart of a process 3200 to educate a customer about credit. The process 3200 may receive one or more questions related to credit from a customer in a chat (element 3210). For instance, the customer may desire to obtain an additional line of credit or installment loan and may submit questions to the question logic circuitry via a chat GUI (or chat box) interface. The question logic circuitry may preprocess the text to identify the words and phrases that correlate with credit subjects and categories and may then correlate the keywords and phrases with the text associated with the credit subjects and categories to identify the credit subject and category with the best correlation to the customer's chat text.

In other embodiments, the question logic circuitry may identify the credit subjects and categories that have a correlation higher than a threshold correlation such as 70 percent or 80 percent. In such embodiments, the question logic circuitry may identify all the credit subjects and categories with the correlation higher than the threshold correlation as education gaps of the customer and may present the customer with credit answers associated with each of the credit subjects and categories to educate the customer about the customer's credit.

After presenting the customer with credit answers associated with each of the credit subjects and categories to educate the customer about the customer's credit, the question logic circuitry may associate the one or more questions with one or more categories of credit subjects (element 3215). In some embodiment, the question logic circuitry may lookup questions in a quiz questions data structure based on the credit subjects and categories stored as education gaps in the customer's profile. In some embodiments, the quiz questions data structure may include more than one question for some of or all the credit subjects and categories, and the question logic circuitry may randomly or pseudo-randomly select a question from the set of questions for a credit subject and category. In further embodiments, the customer profile may include additional information related to quiz questions for some of the credit subjects and categories and the question logic circuitry may select a question from the set of questions for a credit subject and category based on the additional information. For instance, the additional information may include information related to questions that the customer already received during a quiz and answered.

After associating the one or more questions with one or more categories of credit subjects, the question logic circuitry may store indications of the one or more categories of the credit subjects with a customer profile (element 3220). The question logic circuitry may also select questions for a quiz for the customer based on the one or more categories of the credit subjects in the customer profile from a set of questions related to credit (element 3225). Many embodiments include a data structure with a set of quiz questions from which the question logic circuitry may select to generate a quiz for the customer. The question logic circuitry may identify a set of questions based on the one or more categories of the credit subjects in the customer profile, may prioritize the questions based on the use in prior quizzes, level of difficulty, and/or the like. Thereafter, the question logic circuitry may select one or more questions based on the priority associated with the identified set of questions.

The question logic circuitry may present the one or more questions to the customer (element 3230) and may receive answers to the one or more questions from the customer (element 3235). In some embodiments, the answers may be in the form of a true-false answer or a selection of one or more choices for a multiple-choice question. In other embodiments, the answer may be in the form of written answers. After evaluating the answers to determine if the answers match answers associated with the quiz questions, the question logic circuitry may present the customer with the results and may include full explanations from the credit answers that explain the reasons for the correct answers. In other embodiments, the quiz questions may also be associated with explanations for each of the incorrect answers to explain why the answers are not correct.

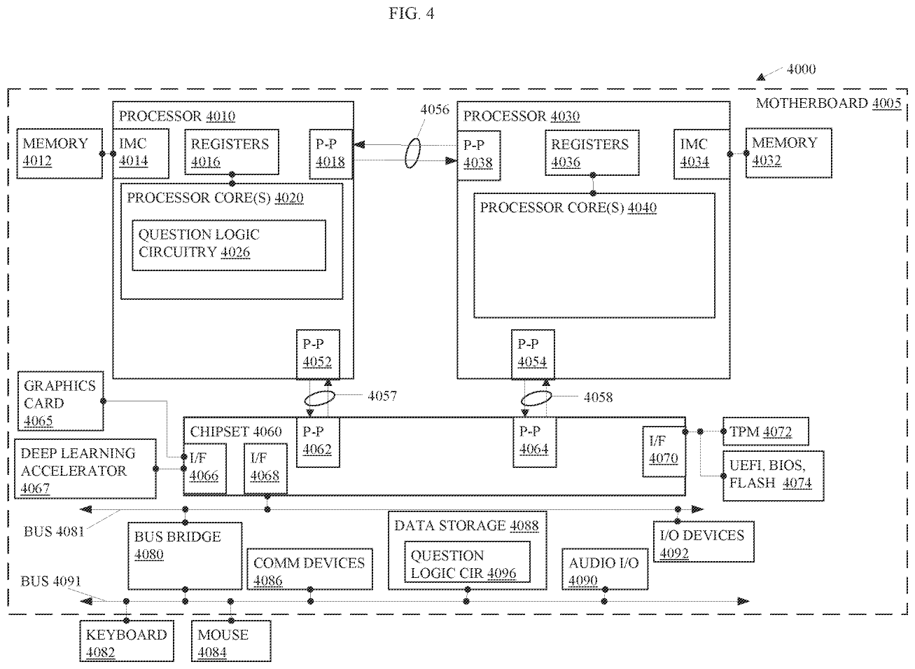

FIG. 4 illustrates an embodiment of a system 4000 such as a server of the server(s) 1010 shown in FIG. 1A, data server(s) 1050 shown in FIG. 1A, or the apparatus 2000 shown in FIG. 2. The system 4000 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the system 4000 may have a single processor with one core or more than one processor. Note that the term “processor” refers to a processor with a single core or a processor package with multiple processor cores.

As shown in FIG. 4, system 4000 comprises a motherboard 4005 for mounting platform components. The motherboard 4005 is a point-to-point interconnect platform that includes a first processor 4010 and a second processor 4030 coupled via a point-to-point interconnect 4056 such as an Ultra Path Interconnect (UPI). In other embodiments, the system 4000 may be of another bus architecture, such as a multi-drop bus. Furthermore, each of processors 4010 and 4030 may be processor packages with multiple processor cores including processor core(s) 4020 and 4040, respectively. While the system 4000 is an example of a two-socket (2S) platform, other embodiments may include more than two sockets or one socket. For example, some embodiments may include a four-socket (4S) platform or an eight-socket (8S) platform. Each socket is a mount for a processor and may have a socket identifier. Note that the term platform refers to the motherboard with certain components mounted such as the processors 4010 and the chipset 4060. Some platforms may include additional components and some platforms may only include sockets to mount the processors and/or the chipset.

The first processor 4010 includes an integrated memory controller (IMC) 4014 and point-to-point (P-P) interconnects 4018 and 4052. Similarly, the second processor 4030 includes an IMC 4034 and P-P interconnects 4038 and 4054. The IMC's 4014 and 4034 couple the processors 4010 and 4030, respectively, to respective memories, a memory 4012 and a memory 4032. The memories 4012 and 4032 may be portions of the main memory (e.g., a dynamic random-access memory (DRAM)) for the platform such as double data rate type 3 (DDR3) or type 4 (DDR4) synchronous DRAM (SDRAM). In the present embodiment, the memories 4012 and 4032 locally attach to the respective processors 4010 and 4030. In other embodiments, the main memory may couple with the processors via a bus and shared memory hub.

The processors 4010 and 4030 comprise caches coupled with each of the processor core(s) 4020 and 4040, respectively. In the present embodiment, the processor core(s) 4020 of the processor 4010 include a question logic circuitry 4026 such as the question logic circuitry 1015 shown in FIG. 1A. The question logic circuitry 4026 may represent circuitry configured to determine and pose quiz questions to educate a customer about credit card usage within the processor core(s) 4020 or may represent a combination of the circuitry within a processor and a medium to store all or part of the functionality of the question logic circuitry 4026 in memory such as cache, the memory 4012, buffers, registers, and/or the like. In several embodiments, the functionality of the question logic circuitry 4026 resides in whole or in part as code in a memory such as the question logic circuitry 4096 in the data storage unit 4088 attached to the processor 4010 via a chipset 4060 such as the education logic circuitries 2020 and 2024 shown in FIG. 2. The functionality of the question logic circuitry 4026 may also reside in whole or in part in memory such as the memory 4012 and/or a cache of the processor. Furthermore, the functionality of the question logic circuitry 4026 may also reside in whole or in part as circuitry within the processor 4010 and may perform operations, e.g., within registers or buffers such as the registers 4016 within the processor 4010, registers 4036 within the processor 4030, or within an instruction pipeline of the processor 4010 or the processor 4030.

In other embodiments, more than one of the processors 4010 and 4030 may comprise functionality of the question logic circuitry 4026 such as the processor 4030 and/or the processor within the deep learning accelerator 4067 coupled with the chipset 4060 via an interface (I/F) 4066. The OF 4066 may be, for example, a Peripheral Component Interconnect-enhanced (PCI-e).

The first processor 4010 couples to a chipset 4060 via P-P interconnects 4052 and 4062 and the second processor 4030 couples to a chipset 4060 via P-P interconnects 4054 and 4064. Direct Media Interfaces (DMIs) 4057 and 4058 may couple the P-P interconnects 4052 and 4062 and the P-P interconnects 4054 and 4064, respectively. The DMI may be a high-speed interconnect that facilitates, e.g., eight Giga Transfers per second (GT/s) such as DMI 3.0. In other embodiments, the processors 4010 and 4030 may interconnect via a bus.

The chipset 4060 may comprise a controller hub such as a platform controller hub (PCH). The chipset 4060 may include a system clock to perform clocking functions and include interfaces for an I/O bus such as a universal serial bus (USB), peripheral component interconnects (PCIs), serial peripheral interconnects (SPIs), integrated interconnects (I2Cs), and the like, to facilitate connection of peripheral devices on the platform. In other embodiments, the chipset 4060 may comprise more than one controller hub such as a chipset with a memory controller hub, a graphics controller hub, and an input/output (I/O) controller hub.

In the present embodiment, the chipset 4060 couples with a trusted platform module (TPM) 4072 and the unified extensible firmware interface (UEFI), BIOS, Flash component 4074 via an interface (I/F) 4070. The TPM 4072 is a dedicated microcontroller designed to secure hardware by integrating cryptographic keys into devices. The UEFI, BIOS, Flash component 4074 may provide pre-boot code.

Furthermore, chipset 4060 includes an I/F 4066 to couple chipset 4060 with a high-performance graphics engine, graphics card 4065. In other embodiments, the system 4000 may include a flexible display interface (FDI) between the processors 4010 and 4030 and the chipset 4060. The FDI interconnects a graphics processor core in a processor with the chipset 4060.

Various I/O devices 4092 couple to the bus 4081, along with a bus bridge 4080 which couples the bus 4081 to a second bus 4091 and an I/F 4068 that connects the bus 4081 with the chipset 4060. In one embodiment, the second bus 4091 may be a low pin count (LPC) bus. Various devices may couple to the second bus 4091 including, for example, a keyboard 4082, a mouse 4084, communication devices 4086 and a data storage unit 4088 that may store code such as the question logic circuitry 4096. Furthermore, an audio I/O 4090 may couple to second bus 4091. Many of the I/O devices 4092, communication devices 4086, and the data storage unit 4088 may reside on the motherboard 4005 while the keyboard 4082 and the mouse 4084 may be add-on peripherals. In other embodiments, some or all the I/O devices 4092, communication devices 4086, and the data storage unit 4088 are add-on peripherals and do not reside on the motherboard 4005.

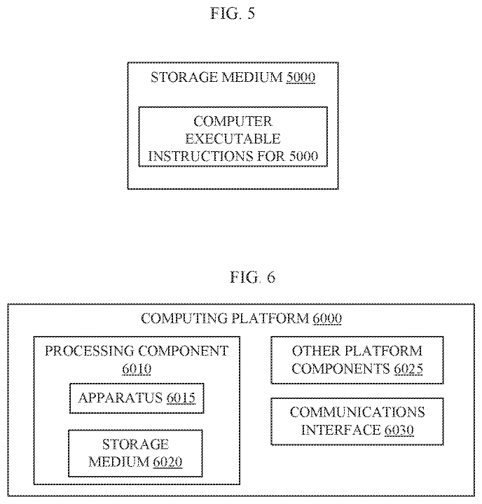

FIG. 5 illustrates an example of a storage medium 5000 to determine and pose quiz questions to educate a customer about credit card usage. Storage medium 5000 may comprise an article of manufacture. In some examples, storage medium 5000 may include any non-transitory computer readable medium or machine readable medium, such as an optical, magnetic or semiconductor storage. Storage medium 5000 may store various types of computer executable instructions, such as instructions to implement logic flows and/or techniques described herein. Examples of a computer readable or machine-readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

FIG. 6 illustrates an example computing platform 6000. In some examples, as shown in FIG. 6, computing platform 6000 may include a processing component 6010, other platform components or a communications interface 6030. According to some examples, computing platform 6000 may be implemented in a computing device such as a server in a system such as a data center or server farm that supports a manager or controller for managing configurable computing resources as mentioned above. Furthermore, the communications interface 6030 may comprise a wake-up radio (WUR) and may be capable of waking up a main radio of the computing platform 6000.

According to some examples, processing component 6010 may execute processing operations or logic for apparatus 6015 described herein such as the question logic circuitry 1015, 2020, and 2024 illustrated in FIGS. 1A and 2, respectively. Processing component 6010 may include various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements, which may reside in the storage medium 6020, may include software components, programs, applications, computer programs, application programs, device drivers, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given example.

In some examples, other platform components 6025 may include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory), solid state drives (SSD) and any other type of storage media suitable for storing information.

In some examples, communications interface 6030 may include logic and/or features to support a communication interface. For these examples, communications interface 6030 may include one or more communication interfaces that operate according to various communication protocols or standards to communicate over direct or network communication links. Direct communications may occur via use of communication protocols or standards described in one or more industry standards (including progenies and variants) such as those associated with the PCI Express specification. Network communications may occur via use of communication protocols or standards such as those described in one or more Ethernet standards promulgated by the Institute of Electrical and Electronics Engineers (IEEE). For example, one such Ethernet standard may include IEEE 802.3-2012, Carrier sense Multiple access with Collision Detection (CSMA/CD) Access Method and Physical Layer Specifications, Published in December 2012 (hereinafter “IEEE 802.3”). Network communication may also occur according to one or more OpenFlow specifications such as the OpenFlow Hardware Abstraction API Specification. Network communications may also occur according to Infiniband Architecture Specification, Volume 1, Release 1.3, published in March 2015 (“the Infiniband Architecture specification”).

Computing platform 6000 may be part of a computing device that may be, for example, a server, a server array or server farm, a web server, a network server, an Internet server, a workstation, a mini-computer, a main frame computer, a supercomputer, a network appliance, a web appliance, a distributed computing system, multiprocessor systems, processor-based systems, or combination thereof. Accordingly, functions and/or specific configurations of computing platform 6000 described herein, may be included or omitted in various embodiments of computing platform 6000, as suitably desired.

The components and features of computing platform 6000 may be implemented using any combination of discrete circuitry, ASICs, logic gates and/or single chip architectures. Further, the features of computing platform 6000 may be implemented using microcontrollers, programmable logic arrays and/or microprocessors or any combination of the foregoing where suitably appropriate. It is noted that hardware, firmware and/or software elements may be collectively or individually referred to herein as “logic”.

It should be appreciated that the computing platform 6000 shown in the block diagram of FIG. 6 may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores”, may be stored on a tangible, machine readable medium and supplied to various customers or manufacturing facilities to load into the fabrication machines that actually make the logic or processor.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, application program interfaces (APIs), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may include an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner, or syntax, for instructing a machine, computing device or system to perform a certain function. The instructions may be implemented using any suitable high-level, low-level, object-oriented, visual, compiled and/or interpreted programming language.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code to reduce the number of times code must be retrieved from bulk storage during execution. The term “code” covers a broad range of software components and constructs, including applications, drivers, processes, routines, methods, modules, firmware, microcode, and subprograms. Thus, the term “code” may be used to refer to any collection of instructions which, when executed by a processing system, perform a desired operation or operations.

Logic circuitry, devices, and interfaces herein described may perform functions implemented in hardware and also implemented with code executed on one or more processors. Logic circuitry refers to the hardware or the hardware and code that implements one or more logical functions. Circuitry is hardware and may refer to one or more circuits. Each circuit may perform a particular function. A circuit of the circuitry may comprise discrete electrical components interconnected with one or more conductors, an integrated circuit, a chip package, a chip set, memory, or the like. Integrated circuits include circuits created on a substrate such as a silicon wafer and may comprise components. And integrated circuits, processor packages, chip packages, and chipsets may comprise one or more processors.

Processors may receive signals such as instructions and/or data at the input(s) and process the signals to generate the at least one output. While executing code, the code changes the physical states and characteristics of transistors that make up a processor pipeline. The physical states of the transistors translate into logical bits of ones and zeros stored in registers within the processor. The processor can transfer the physical states of the transistors into registers and transfer the physical states of the transistors to another storage medium.

A processor may comprise circuits to perform one or more sub-functions implemented to perform the overall function of the processor. One example of a processor is a state machine or an application-specific integrated circuit (ASIC) that includes at least one input and at least one output. A state machine may manipulate the at least one input to generate the at least one output by performing a predetermined series of serial and/or parallel manipulations or transformations on the at least one input.

The logic as described above may be part of the design for an integrated circuit chip. The chip design is created in a graphical computer programming language and stored in a computer storage medium or data storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication.

The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher-level carrier) or in a multichip package (such as a ceramic carrier that has either or both surface interconnections or buried interconnections). In any case, the chip is then integrated with other chips, discrete circuit elements, and/or other signal processing devices as part of either (a) an intermediate product, such as a processor board, a server platform, or a motherboard, or (b) an end product.

What is claimed is:

1. An apparatus comprising:
memory; and
logic circuitry coupled with the memory to:
receive one or more questions from a customer in a chat;
associate the one or more questions with one or more categories of subjects;
store indications of the one or more categories of the subjects with a customer profile;
select questions for a quiz for the customer based on the one or more categories of the subjects in the customer profile from a set of questions;
present the one or more questions to the customer; and
receive answers to the one or more questions from the customer.

2. The apparatus of claim 1, further comprising the logic circuitry to offer a reward to the customer for participation in the quiz.

3. The apparatus of claim 2, further comprising the logic circuitry to process the reward for the customer in response to correct answers to each of the one or more questions.

4. The apparatus of claim 1, further comprising the logic circuitry to store a result of the quiz in the customer profile, the result of the quiz indicative of the customer's knowledge of one or more of the categories of the subjects.

5. The apparatus of claim 4, wherein selection of one or more questions for the quiz for the customer from the set of questions is based on the result of the quiz.

6. The apparatus of claim 1, further comprising the logic circuitry to provide the indications of the one or more of the categories of the subjects to a quiz model, wherein the quiz model is a machine learning engine, the quiz model to select the one or more questions from the set of questions for the quiz based on the indications of the one or more of the categories of the subjects.

7. The apparatus of claim 6, further comprising the logic circuitry to provide results for one or more quizzes performed by the customer to the quiz model, the quiz model to select the one or more questions from the set of questions for the quiz based on the results.

8. The apparatus of claim 6, further comprising the logic circuitry to provide additional information about the customer from the customer profile, the additional information comprising one or more characteristics of the customer, the quiz model to select the one or more questions from the set of questions for the quiz based on the one or more characteristics of the customer.

9. A non-transitory storage medium containing instructions, which when executed by a processor, cause the processor to perform operations, the operations to:
interact with a customer to receive one or more questions from the customer;
associate the one or more questions with one or more categories of subjects;
store indications of the one or more categories of the subjects with a customer profile;
select one or more questions for a quiz for the customer from a set of questions, based on the indications of the one or more categories of the subjects in the customer profile;
present the quiz to the customer, wherein the quiz comprises the one or more questions; and
receive answers to the one or more questions from the customer.

10. The non-transitory storage medium of claim 9, wherein the operations further comprise operations to offer a reward to the customer for participation in the quiz.

11. The non-transitory storage medium of claim 10, wherein the operations further comprise operations to process the reward for the customer in response to correct answers to each of the one or more questions.

12. The non-transitory storage medium of claim 9, wherein the operations further comprise operations to store a result of the quiz in the customer profile, the result of the quiz indicative of the customer's knowledge of one or more of the categories of the subjects.

13. The non-transitory storage medium of claim 12, wherein selection of one or more questions for the quiz for the customer from the set of questions is based on the result of the quiz.

14. The non-transitory storage medium of claim 9, wherein the operations further comprise operations to provide the indications of the one or more of the categories of the subjects to a quiz model, wherein the quiz model is a machine learning engine, the quiz model to select the one or more questions from the set of questions for the quiz based on the indications of the one or more of the categories of the subjects.

15. The non-transitory storage medium of claim 14, wherein the operations further comprise operations to provide results for one or more quizzes performed by the customer to the quiz model, the quiz model to select the one or more questions from the set of questions for the quiz based on the indications of the one or more of the categories of the subjects.

16. The non-transitory storage medium of claim 15, wherein selection of one or more questions for the quiz for the customer based on results for one or more quizzes comprises selection of questions having a level of difficulty based on the customer's ability to answer questions from the quizzes correctly.

17. A method comprising:
receiving, by a processor, one or more questions from a customer in a chat;
associating the one or more questions with one or more categories of subjects;
storing indications of the one or more categories of the subjects with a customer profile;
selecting one or more questions for a quiz for the customer from a set of questions, based on the indications of the one or more categories of the subjects in the customer profile;
presenting the quiz to the customer with the one or more questions; and
receiving answers to the one or more questions from the customer.

18. The method of claim 17, further comprising storing a result of the quiz in the customer profile, the result of the quiz indicative of the customer's knowledge of one or more of the categories of the subjects.

19. The method of claim 17, further comprising providing the indications of the one or more categories to a quiz model, wherein the quiz model is a machine learning engine, the quiz model to select the one or more questions from the set of questions for the quiz based on the indications of the one or more of the categories of the subjects.

20. The method of claim 19, further comprising providing additional information about the customer from the customer profile, the additional information to comprise one or more characteristics of the customer, the quiz model to select the one or more questions from the set of questions for the quiz based on the one or more characteristics of the customer.
